(19) United States
(12) Patent Application Publication
(10) Pub. No.: US 2026/0049013 A1
(43) Pub. Date: Feb. 19, 2026

(54) System and Method for Enhancing the Water Production of Atmospheric Water Generators

(71) Applicant: Aerosolization Enterprises International, LLC, Cornelius, NC (US)

(72) Inventor: Kelly K. Houston, Cornelius, NC (US)

(21) Appl. No.: 19/288,165

(22) Filed: Aug. 1, 2025

Related U.S. Application Data
(60) Provisional application No. 63/683,744, filed on Aug. 16, 2024.

(51) Int. Cl. C02F 1/74; B01D 5/00; C02F 1/20; C02F 3/30; C02F 101/00; C02F 101/16; C02F 101/32

(52) U.S. Cl. CPC C02F 1/74; B01D 5/0057; C02F 1/20; C02F 3/303; C02F 2101/006; C02F 2101/16; C02F 2101/322

(57) ABSTRACT

A system and process recovers water from a water source through an aerosolization process and a process that employs an atmospheric water generator (AWG). In particular, the water source is directed through the aerosolization system, which produces a dual-flow effluent comprising very fine water droplets entrained in air. The effluent is discharged in the vicinity of the AWG which increases the relative humidity in and around the AWG which enhances the AWG's ability to efficiently produce water.

### RELATED APPLICATIONS

This application claims the benefit of U.S. Provisional Application No. 63/683,744, filed on Aug. 16, 2024, which is hereby incorporated by reference in its entirety.

### FIELD OF THE INVENTION

The present invention relates to atmospheric water generators and processes for generating water from humidity in the atmosphere.

### BACKGROUND OF THE INVENTION

Atmospheric water generators (AWGs) are devices or systems that extract water from the humidity in the air. They are designed to provide a sustainable and alternative source for either potable or non-potable water, particularly in areas where traditional water sources are scarce or unreliable.

AWGs are used in a variety of settings, including residential homes, offices, and remote areas where conventional water sources may not be available. They are particularly useful in regions with high humidity as the efficiency of water generation increases with the moisture content of the air.

While AWGs offer innovative solutions for water scarcity, they have one major drawback. They are humidity dependent. In many applications, the humidity in the air around the AWG is relatively low, and in many cases is so low that it is not economically feasible to employ an AWG to generate water. In addition, in some geographical areas changes in the season can drastically affect the output and efficiency of an AWG because, as seasons change, so does the humidity in the air.

Therefore, there is a need to address this major drawback for AWGs. More particularly, there is a need to develop a means for economically and feasibly increasing the humidity in the air around an AWG in order to increase its efficiency and to make water generation from the humidity in the air justifiable.

### SUMMARY OF THE INVENTION

The present invention is also directed to an indirect water recovery system and process that utilizes aerosolization and condensation. The system and process disclosed here is essentially an atmospheric humidity enhancement system comprising an aerosol-driven humidity booster for an AWG.

The present invention relates to a process for increasing the efficiency of an AWG by intentionally increasing the humidity in the air around the AWG. By increasing the humidity around the AWG, water production of the AWG is increased and the overall efficiency of the water production process is substantially enhanced.

The process of the present invention entails stationing an aerosolization system in the vicinity of an AWG. Water from a water source, such as contaminated water, is pumped under pressure into the aerosolization system and aerosolized. Aerosolized water is discharged from the aerosolization system into the air around or in the vicinity of the AWG, thereby increasing the humidity in the atmosphere around the AWG. The term “contaminated water” means water containing two or more contaminants. Air containing the increased humidity is directed into the AWG where the humidity is converted into water.

Further, the process of the present invention entails enhancing the humidity of the air around the AWG by utilizing wastewater located in the vicinity of the aerosolization system. Wastewater containing suspended solids and/or other contaminants is pumped into the aerosolization system and dispersed therein through nozzles. A system of air sweeps through the aerosolization system and the aerosolized wastewater is entrained in the system of air to form an aerosolized air-water mixture. The aerosolized air-water mixture, containing the suspended solids, is discharged from the aerosolization system. Suspended solids contained in the air-water mixture will fall out, leaving the aerosolized water that gives rise to an increase in the humidity around the AWG in the atmosphere.

In some embodiments, the wastewater includes contaminants that can be treated through aeration. For example, the contaminated water treated by the present system and process may include volatile organic compounds, such as benzene, dissolved gases, such as hydrogen sulfide, carbon dioxide, and methane, metals, such as iron and manganese and algae. Since the aerosolization system aerates the contaminated water passing through the system, a level of treatment is provided and this treatment improves the quality of the initial contaminated water.

The present invention also provides a system and process for recovering potable or non-potable water from contaminated or non-potable water sources by aerosolizing the contaminated water using an air-assisted aerosolization system. The resulting aerosolized effluent is introduced into the air surrounding an AWG. As the water droplets that form a part of the effluent from the aerosolization system evaporate, water vapor increases the local humidity in the vicinity of the AWG. The AWG in turn condenses this vapor producing water that is cleaner than the initial water.

Other objects and advantages of the present invention will become apparent and obvious from a study of the following description and the accompanying drawings which are merely illustrative of the invention.

### BRIEF DESCRIPTION OF THE DRAWING

FIG. 1 is a schematic illustration of an aerosolization system and an atmospheric water generator (AWG), both of which are stationed in an area where the aerosolization system is capable of increasing the humidity in the air in the vicinity of the AWG.

FIG. 2 is a schematic illustration of a method or process where contaminated or wastewater is treated in an aerosolization process, and wherein the treated effluent from the aerosolization process is discharged into an area occupied by the AWG and effectively increase the relative humidity in the vicinity of the AWG.

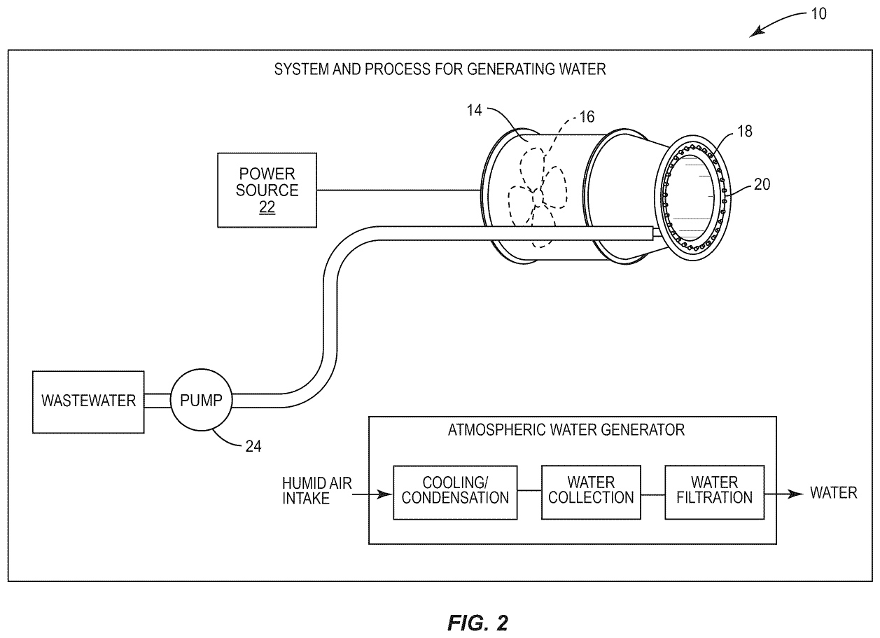

FIG. 3 is a schematic illustration of a process similar to that shown in FIG. 2, but including an exemplary wastewater treatment system upstream of the aerosolization process.

### DESCRIPTION OF EXEMPLARY EMBODIMENT

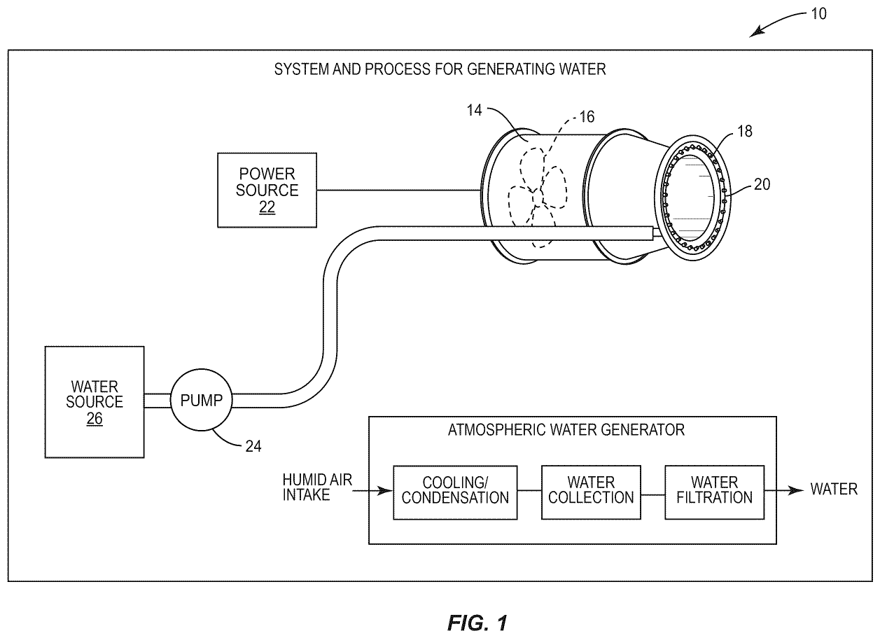

With further reference to FIG. 1, an aerosolization machine 10 is shown therein, along with a schematic illustration of an atmospheric water generator (AWG) 8. As discussed below, the process of the present invention employs the aerosolization system 10 to generate humidity in the air around or in the vicinity of the AWG 8. References made to increasing the humidity or relative humidity in the vicinity of the AWG. This means that the humidity or relative humidity is increased in an area within one square mile of the AWG. Furthermore, the aerosolization system or device is placed in the vicinity of the AWG. This means that the aerosolization system is within one square mile of the AWG.

Air containing this increased humidity is directed into the AWG, which converts the humidity in the air to water. By increasing the humidity in the vicinity of the AWG, this increases both the efficiency and the water production of the AWG. By enhancing the humidity around AWG 8, environments that are typically marginal for efficiently converting humidity to water now become suitable environments for generating water.

First and with further reference to FIG. 1, a schematic illustration of an AWG is shown therein. Details of the AWG are not dealt with herein because such is not per se material to the present invention and the basic structure and operation of an AWG is well known and appreciated by those skilled in the art. However, for a more complete and unified understanding of a typical AWG, one is referred to the disclosure in U.S. Patent Pub. 2021/0162314, the disclosure thereof being expressly incorporated herein by reference.

In any event, it may be beneficial to briefly review the basic components and function of an AWG. The basic structure of an AWG includes an air intake system, a cooling/condensation unit, a water collection and storage unit, a filtration system, and a water dispensing system. The air intake system draws in ambient air from the surrounding environment. It often includes filters to remove dust, pollen and other airborne particles to ensure clean humid air is used in the water generation process. A central part of an AWG is a cooling mechanism, typically employing a refrigeration cycle similar to an air conditioner. Air is cooled below its dew point causing the moisture in the air to condense into water droplets. The condensed water droplets are collected. Once the water droplets are formed and condensed, the condensed water is directed into a collection chamber or tank. In some embodiments, the AWG is provided with a filtration system. The collected water is typically directed through multiple filtration stages, such as activated carbon filters, UV sterilization and reverse osmosis. These filters remove any remaining impurities, bacteria or viruses, ensuring that the water is safe to drink in the case of potable water. In cases where the AWG is generating non-potable water, it may be appropriate for the AWG not to include sophisticated filtration. Finally, the AWG includes a water dispensing system that dispenses the water from the generator. As will be described below, some cases of the AWG can be used to generate non-potable water.

Now turning to the aerosolization system 10, it is seen that it includes a conduit 14 that is designed to direct air through the aerosolization system. A large turbine 16 is mounted in the conduit 14 and is rotatively mounted on a shaft that forms a part of the aerosolization system. Turbine 16 is driven such that it generates a system of air that moves through the conduit from an inlet end to and through an outlet end. Aerosolization system 10 includes a water injection system for aerosolizing water and injecting the aerosolized water into the system of air passing through the conduit 14. The aerosolization system contains an array of adjustable and replaceable nozzles 18 that are secured and circumferentially spaced around a pipe manifold 20. As will be seen from discussions below, water being aerosolized by the aerosolization system 10 is directed under pressure into the manifold 20 and from the manifold the water is aerosolized outwardly from the series of nozzles 18. Note that the nozzles 18 are oriented about the outlet end portion of the conduit 14. Moreover, the nozzles 18 are directed inwardly such that the aerosolized water is directed inwardly towards the center of the conduit 14. The dispersed aerosolized water mixes with the system of air passing through the conduit to form an aerosolized air-water mixture. This aerosolized air-water mixture is discharged from the outward end of the conduit 14 into the atmosphere where the aerosolized water increases the humidity in the air around the aerosolization system 10. To power the aerosolization system 10 and particularly to drive the turbine 16, there is provided an integrated power source 22. Various types of power sources can be utilized. In one embodiment, the power source is a diesel or gasoline internal combustion engine that is operatively connected to a drive shaft that drives the turbine. In other embodiments, the power source can be an electric motor operatively connected to the drive shaft of the turbine 16 where the electric motor is powered by an integrated conventional generator.

Forming part of the aerosolization system 10 is one or more pumps 24. Pumps 24 function to pump water from a water source 26 into the manifold 20 and out the nozzles 18. In some cases, the aerosolization system may include a tank or storage vessel for holding the water to be disseminated via the aerosolization system. FIG. 1 shows the conduit 14, as well as the nozzles 18, disposed about the outlet end of the conduit 14. Air, in addition to water, is injected into the air stream to form the aerosolized air-water mixture. The air functions at least partially as a carrier for the aerosolized water. In addition, because of the velocity and energy associated with the moving stream that is being propelled from the outlet of the conduit 14, the aerosolization system 10 facilitates the further aerosolization of the water. The aerosolization system is designed to throw the aerosolized air-water mixture a substantial distance from the outlet end of the conduit 14. It is appreciated by those skilled in the art that by increasing the power for driving the turbine 16, it is possible to propel the aerosolized air-water mixture far into the atmosphere. From there the aerosolized air-water mixture can drift miles and the impact of the increase in humidity in the air can be felt far away from the aerosolization system 10.

In some cases, the aerosolization system is mounted on a mobile platform such that it can be moved from point-to-point and placed in a desirable location with respect to the AWG 8. In addition, the aerosolization system can be mounted on the platform such that it can be rotated about a vertical axis a full 360°.

The present invention aims at increasing the humidity or relative humidity in the air in a geographical area in the vicinity of the AWG 8. These two machines do not have to be located close to each other. Indeed, it is postulated that the aerosolization system 10 can be operated at an efficiency and power level that will impact the humidity in and around the AWG 8 throughout a one square mile area. That is, it is postulated that the aerosolization system 10 will sufficiently increase the humidity within a one square mile area sufficient that the increase in humidity caused by the aerosolization machine impacts the efficiency of water production of the AWG. When water is aerosolized, it is dispersed into the air as tiny droplets of water vapor. This process adds moisture to the surrounding air, raising its humidity level. When water is dispersed in the air, whether through spraying, misting or aerosolization, some of it evaporates into water vapor. The vapor increases the concentration of water molecules in the air, thereby raising the relative humidity. The degree to which aerosolization affects humidity depends on several factors, including the volume of water aerosolized, the temperature, the initial humidity level of the air, and air circulation. For instance, in a hot, dry environment, the added moisture would more likely be absorbed by the air, potentially leading to a more significant increase in humidity.

As to the source of water for the aerosolization machine, this could be any source of water including pond water, lake water, etc. In addition, for small applications, one can consider using rainwater harvesting or the collection of water from other appliances to be directed into the aerosolization system.

One source of water for the aerosolization machine is wastewater. Wastewater, of course, contains contaminants, suspended solids, etc. There are various forms of contaminated wastewater as recognized and appreciated by people skilled in the art. For example, some wastewater treatable by the system and process of the present invention includes contaminants such as nitrogen, phosphorus, heavy metals such as lead, mercury, etc. and salts such as chlorides and sulfates. The system and process of the present invention is also suitable for treating and dealing with water containing radioactive materials. One additional benefit of employing an aerosolization machine to enhance humidity is that in the case of the water source being wastewater, the aerosolization process tends to separate the contaminants, especially suspended solids, from the aerosolized water vapor that acts to increase the humidity in the atmosphere. This means that, even in the case of wastewater, the aerosolization system will, to at least some extent, purify the wastewater which means that it may by possible to operate an AWG without substantial filtration capability. This will reduce initial costs of the AWG and reduce operating costs.

The aerosolization system 10 can treat the contaminated water or wastewater through aeration. This is particularly true where the contaminated water or wastewater includes volatile organic compounds, such as benzene, dissolved gases, such as hydrogen sulfide, carbon dioxide, and methane, and metals, such as iron and manganese. Aeration accompanying the aerosolization process helps strip volatile organic compounds from the contaminated water and tends to remove unwanted gases, such as hydrogen sulfide, carbon dioxide, and methane. Further, aeration performed by the aerosolization system oxidizes iron and manganese and the resulting particles can be removed through filtration or a solids-liquid separation unit, or the solids can be separated from the aerosolized-treated water effluent discharged from the aerosolization system. To the extent that precipitants and other suspended solids are not separated through a solids-liquid separation unit upstream of the aerosolization system, these precipitants and other suspended solids will tend to fall out of the aerosolized treated water effluent being discharged by the aerosolization system.

Hence, the aerosolization system produces an aerosolized air-treated water mixture that is discharged in the vicinity of the AWG. The discharge is a fine mist or aerosolize spray containing high surface area micron or sub-millimeter-sized water droplets entrained in air. Essentially, this constitutes a two-phase aerosolized flow that humidifies the area in the vicinity of the AWG.

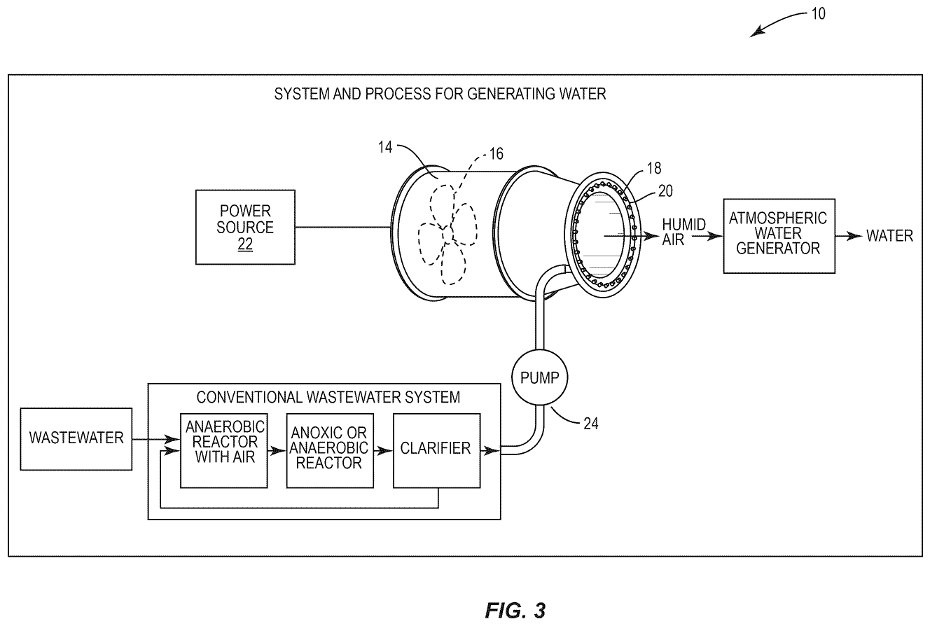

FIG. 3 is an exemplary process where wastewater is subjected to a conventional wastewater treatment system before being directed in the aerosolization system. Various types of wastewater treatment systems can be employed depending on the particular contaminants in the wastewater. In the case of the example shown in FIG. 3, the wastewater treatment system includes two biological reactors, an aerobic reactor followed by an anoxic or anaerobic reactor, which is followed by a solids-liquid separation unit which in this case is a clarifier. In this form, the wastewater treatment system could be used for BOD removal. This occurs in the aerobic reactor where organic matter is biologically oxidized by aerobic bacteria. In addition, the aerobic reactor could perform nitrification. Here, ammonia (NH₃/NH₄⁺) is converted to nitrate by nitrifying bacteria. This is carried out under aerobic conditions. In addition, the second reactor, when operated as an anoxic reactor, is effective for denitrification. Here, the nitrate (NO₃⁻) from the aerobic reactor is converted to nitrogen gas (N₂) by denitrifying bacteria. In most cases, the wastewater being treated would include suspended solids and those would be removed in the clarifier. This is a simply example of a conventional wastewater treatment system to biologically remove contaminants from the wastewater before the wastewater or contaminated water is subjected to intense aeration in the aerosolization system 10.

The aerosolization system and AWG are particularly suitable for outdoor use. The entire system can be employed on land that might even be legally deemed as contaminated. In some applications, the AWG is a very large machine or device and is moved about by mechanical means so as to best position the AWG to efficiently produce water from the increased humidity brought about by the aerosolization system and process. Water produced by the AWG can be used on site or transported to other locations.

There are many advantages to the present invention. By employing an aerosolization machine or system to increase the humidity around an AWG, this will result in a more efficient water production process and in the end will produce greater volumes of water. Furthermore, there are situations where the feasibility of utilizing an AWG to produce water is marginal. However, by employing an aerosolization system in conjunction with an AWG, then many of those marginal situations now become economically feasible and practical. This is especially true in environments where the AWG is located in areas where there is easy access to water in ponds, lakes, and streams, and even facilities that include wastewater. Aerosolization can be done anywhere at any time and AWGs can be used most anywhere in the world with the requirement that they need some level of humidity to produce water from the air. Both the technologies described herein can run continuously and are mobile, simple, modular, and economical. The problems addressed here enable the production of cheap, local and plentiful water that can be used for various potable and non-potable purposes and can be created from any type of water source that can be aerosolized.

The present invention may, of course, be carried out in other specific ways than those herein set forth without departing from the scope and the essential characteristics of the invention. The present embodiments disclosed herein are therefore to be construed in all respects as illustrative and not restrictive and all changes coming within the meaning and equivalency range of the appended claims are intended to be embraced therein.

What is claimed is:

1. A method of treating contaminated water through aeration and converting the contaminated water to treated non-potable water comprising:
stationing an atmospheric water generator (AWG) in the vicinity of an aerosolization system;
pumping the contaminated water under pressure to a series of nozzles positioned in the aerosolization system;
driving a turbine that forms a part of the aerosolization system and generating a system of air that passes through the aerosolization system and past the nozzles;
aerosolizing the contaminated water directed from the nozzles into the system of air passing through the aerosolization system to form an aerosolized treated water mixture;
increasing the relative humidity in the vicinity of the AWG by discharging the aerosolized treated water mixture from the aerosolization system into the air in the vicinity of the AWG;
after increasing the relative humidity in the air in the vicinity of the AWG, intaking the air having the increased relative humidity into the AWG; and
in the AWG, generating water from the humidity in the air taken into the AWG.

2. The method of claim 1 wherein the contaminated water includes volatile organic compounds and one or more dissolved gases, and wherein the method of aerating the contaminated water through the aerosolization system reduces the concentration of the volatile organic compounds, as well as reducing the concentration of the one or more dissolved gases in the contaminated water.

3. The method of claim 1 wherein the aerosolization system includes a discharge point that is located within one mile of the AWG.

4. The method of claim 1 including the step of biologically treating the contaminated water prior to the contaminated water being pumped into the aerosolization system, and wherein the biological treatment of the contaminated water reduces the biochemical oxygen demand (BOD) of the contaminated water prior to the contaminated water entering the aerosolization system.

5. The method of claim 1 wherein the contaminated water includes algae and the method includes aerating the wastewater containing algae as the wastewater passes through the aerosolization system.

6. The method of claim 1 wherein the contaminated water contains radioactive material.

7. A method of generating water from the atmosphere comprising:
stationing an atmospheric water generator (AWG) in the vicinity of an aerosolization system;
increasing the humidity of air in the atmosphere in the vicinity of the AWG by:
i. connecting the aerosolization system to a source of water;
ii. driving a turbine that forms a part of the aerosolization system and generating a system of air that passes through the aerosolization system;
iii. pumping water from the water source under pressure to a series of nozzles positioned in the aerosolization system and aerosolizing the water directed from the nozzles into the system of air passing through the aerosolization system to form an aerosolized air-water mixture;
iv. discharging the aerosolized air-water mixture from the aerosolization system into the atmosphere;
intaking air having at least some of the humidity generated by the aerosolization system into the AWG; and
in the AWG, generating water from the humidity in the air taken into the AWG.

8. The method of claim 7 wherein the source of the water is wastewater containing suspended solids.

9. The method of claim 8 wherein the aerosolization system purifies the wastewater by separating suspended solids from the aerosolized air-water mixture.

10. The method of claim 8 wherein the wastewater contains algae and wherein the method includes aerating the wastewater containing algae by directing the wastewater through the aerosolization system wherein aerating the algae breaks down the algae and reduces the organic load in the wastewater passing through the aerosolization system.
